(19) United States
(12) Patent Application Publication
(10) Pub. No.: US 2020/0002088 A1
(43) Pub. Date: Jan. 2, 2020

(54) ANTI-MICROBIAL DISCREET PERSONAL HYGIENE ITEM DISPOSAL BAG

(71) Applicant: Guerline Ocean, Auburndale, FL (US)

(72) Inventor: Guerline Ocean, Auburndale, FL (US)

(21) Appl. No.: 16/268,470

(22) Filed: Feb. 5, 2019

Related U.S. Application Data
(60) Provisional application No. 62/626,376, filed on Feb. 5, 2018.

(51) Int. Cl. B65F 1/00

(52) U.S. Cl. CPC B65F 1/0026; B65F 1/002

(57) ABSTRACT

Anti-microbial, discreet personal hygiene item disposal bags are described.

### RELATED APPLICATIONS

This application claims the benefit of U.S. Application No. 62/626,376, entitled “ANTI-MICROBIAL DISCREET PERSONAL HYGIENE ITEM DISPOSAL BAG,” and filed on Feb. 5, 2018, which is incorporated herein by reference in its entirety.

### TECHNICAL FIELD

Some implementations relate generally to disposal bags, and more particularly, to anti-microbial, discreet personal hygiene item disposal bags.

### BRIEF DESCRIPTION OF THE DRAWINGS

FIG. 1 is a diagram of an example anti-microbial, discreet personal hygiene item disposal bag in accordance with some implementations.

### DETAILED DESCRIPTION

Disposing of personal hygiene items such as sanitary pads, tampons, panty liners, diapers, cotton swabs, tooth picks, and incontinence protection products can present numerous challenges, especially in settings, facilities or venues that accommodate large numbers of people such as amusement parks, entertainment venues, hospitality venues (e.g., hotels, resorts, etc.), cruise ships, airplanes, trains, passenger vehicles, recreational vehicles, shopping venues, correctional facilities, schools, etc. People disposing of used personal hygiene items may desire a discreet and sanitary way to handle and dispose of the items. Facility and venue operators may desire to provide a safe, sanitary, discreet, and/or pleasant way for people in the facility or venue to dispose of used personal hygiene items so as to enhance safety and comfort and/or provide a more aesthetically pleasing experience for visitors or guests.

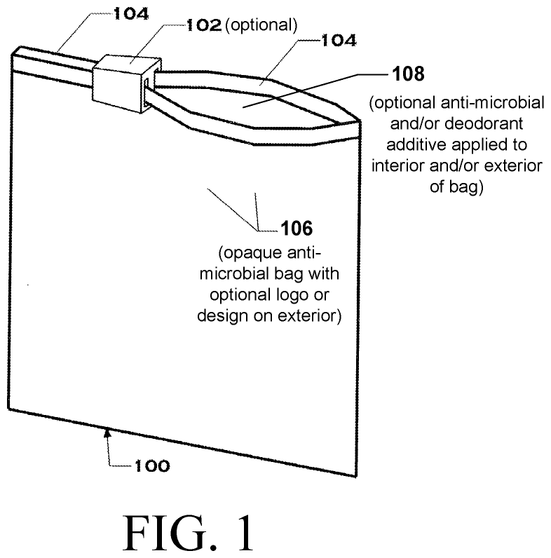

FIG. 1 is a diagram of an example anti-microbial, discreet personal hygiene item disposal bag 100 in accordance with some implementations. The bag 100 can include a resealable closure 104 (e.g., a Ziplock-style closure, adhesive strip, etc.) with an optional slider 102 to seal and unseal the bag 100. The bag 100 can be formed from opaque material 106 (e.g., opaque polyethylene, or opaque high-density polyethylene (HDPE), black or dark colored plastic, or a black or dark colored pigment applied to the exterior or interior of the bag) and optionally have a design or logo applied to the bag to help conceal the contents and/or for aesthetics, appearance, branding, instructions, etc. The bag 100 can be formed from plastic that is optionally biodegradable having embedded or built-in anti-microbial properties and/or can have optional additives 108 applied to the interior and/or exterior of the bag to provide anti-microbial and/or deodorant properties (e.g., baking soda scented deodorant additives, etc.). The specific additive(s) used for the anti-microbial and/or deodorant properties can be selected based on a contemplated use of the bag 100. For example, a bag 100 for disposing of a feminine hygiene product may have anti-microbial and/or deodorant additives suited for blood, while a bag 100 for use with incontinence personal hygiene items may have anti-microbial and/or deodorant additives suitable for urine and/or feces.

The bag 100 can be formed in various sizes to accommodate different applications such as disposal of feminine hygiene products (e.g., a 2 inch by 3 inch bag, or a bag having similar dimensions to a typical sandwich bag), disposal of adult incontinence or other personal hygiene items (e.g., a gallon size bag).

In some implementations, the bag 100 could be used as a wrapper to enclose an unused personal hygiene item so as to discreetly mask the appearance of the unused person hygiene item and to be available for disposal of a used personal hygiene item when changing the used personal hygiene out for the unused personal hygiene item.

It is, therefore, apparent that there is provided, in accordance with the various implementations disclosed herein, anti-microbial, discreet personal hygiene item disposal bags.

While the disclosed subject matter has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the disclosed subject matter.

What is claimed is:

1. A discreet personal hygiene item disposal bag comprising:
a rectangular first side attached along three edges to a rectangular second side; and
a closure attached to a fourth edge of the rectangular first side and a fourth edge of the rectangular second side,
wherein the rectangular first side and the rectangular second side are formed from opaque material,
wherein an antimicrobial agent is applied to at least one of an inside surface of the rectangular first side or an inside surface of the rectangular second side.

2. The discreet personal hygiene item disposal bag of claim 1, wherein the rectangular first side and the rectangular second side are formed from polyethylene.

3. The discreet personal hygiene item disposal bag of claim 1, wherein the closure includes a resealable closure.

4. The discreet personal hygiene item disposal bag of claim 1, further comprising a deodorant applied to at least one of an inside surface of the rectangular first side or an inside surface of the rectangular second side.

5. The discreet personal hygiene item disposal bag of claim 1, wherein the rectangular first side and the rectangular second side are formed to have a capacity, when joined together and sealed with the closure, to hold a feminine personal hygiene item.

6. The discreet personal hygiene item disposal bag of claim 1, wherein the rectangular first side and the rectangular second side are formed to have a capacity, when joined together and sealed with the closure, to hold an incontinence protection item.

7. The discreet personal hygiene item disposal bag of claim 1, wherein the discreet personal hygiene item disposal bag is formed as a wrapper to enclose an unused personal hygiene item so as to discreetly mask the appearance of the unused person hygiene item and to be available for disposal of a used personal hygiene item when changing the used personal hygiene out for the unused personal hygiene item.

8. The discreet personal hygiene item disposal bag of claim 1, wherein the discreet personal hygiene item disposal bag is formed from biodegradable material.
